(19) United States
(12) Patent Application Publication
(10) Pub. No.: US 2016/0015034 A1
(43) Pub. Date: Jan. 21, 2016

(54) Co-Crystals of Pyrimethanil and Selected Dithiine Tetracarboximide

(71) Applicant: BASF SE, Ludwigshafen (DE)

(72) Inventors: Matthias BRATZ, Maxdorf (DE); Tiziana CHIODO, Mannheim (DE); Dennis KOULELIS, Frankenthal (DE); Murat MERTOGLU, Ludwigshafen (DE)

(21) Appl. No.: 14/773,033

(22) PCT Filed: Feb. 25, 2014
(86) PCT No.: PCT/EP2014/053576

§ 371 Date: Sep. 4, 2015

(30) Foreign Application Priority Data
Mar. 7, 2013 (EP) 13158189.4

(51) Int. Cl. A01N 43/90; A01N 43/54

(52) U.S. Cl. CPC A01N 43/90; A01N 43/54

(57) ABSTRACT

Co-crystals comprising
(I) pyrimethanil; and
(II) dithiine tetracarboximide of the formula (I)

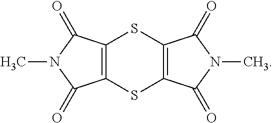 [SMILES: Cn1c(=O)c2sc3c(=O)n(C)c(=O)c3sc2c1=O]

The present invention relates to co-crystals of pyrimethanil and dithiine tetracarboximide of the formula I

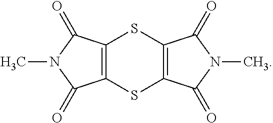 [SMILES: Cn1c(=O)c2sc3c(=O)n(C)c(=O)c3sc2c1=O]

The present invention relates further to a process for preparing such co-crystals. Further the present invention relates to agriculturally useful formulation comprising such co-crystals and to method using said co-crystals.

Co-crystals are multi-component crystals or crystalline materials that consist of at least two different organic compounds which are usually solid at 25° C. or at least a non-volatile oil (vapour pressure less than 1 mbar at 25° C.). In the co-crystals (or co-crystales) at least two different organic compounds form a crystalline material having a defined crystal structure, i. e. at least two organic compounds have a defined relative spatial arrangement within the crystal structure.

In the co-crystals, at least two different compounds interact by non-covalent bonding, hydrogen bonds and/or other non-covalent intermolecular forces, including-stacking, dipole-dipole interactions and van der Waals interactions.

Although the packing in the crystalline lattice cannot be designed or predicted, several supramolecular synthons could successfully be recognized in co-crystals. The term “supramolecular synthon” has to be understood as an entity of usually two compounds that are bonded together via non-covalent interactions, in the most typical case hydrogen bonding. In co-crystals these synthons further pack in the crystalline lattice to form a molecular crystal. Molecular recognition is one condition of the formation of the synthon. However, the co-crystal must also be energetically favourable, i.e. an energy win in the formation of the co-crystal is also required, as molecules typically can pack very efficiently as crystals of pure components thereby hindering the co-crystal formation.

In co-crystals one of the organic compounds may serve as a co-crystal former, i. e. a compound which itself easily forms a crystalline material and which is capable of forming co-crystals with other organic compounds which themselves may not necessarily form a crystalline phase.

Agriculturally active organic compounds (pesticides) such as fungicides, herbicides and insecticides or acaricides are usually marketed as liquid or solid formulations which comprise one or more agriculturally active organic compounds and suitable formulation additives. For several reasons, formulation types are preferred, wherein the agriculturally active organic compound is present in the solid state, examples including solid formulations such as dusts, powders or granules and liquid formulations such as suspension concentrates, i.e. aqueous compositions containing the pesticide as fine particles which are dispersed in the aqueous medium or suspo emulsions, i.e. aqueous compositions containing one pesticide as fine particles which are dispersed in the aqueous medium and a further pesticide solubilized in an organic solvent. Suspension concentrates or suspo-emulsion have the desirable characteristics of a liquid that may be poured or pumped and which can easily be diluted with water to the desired concentration required for application. In contrast to emulsion concentrates the suspension concentrates have the added advantage of not requiring the use of water-immiscible organic solvents. Suspo-emulsions have the advantage of providing the possibility to formulate more than one pesticide in the same concentrate—besides the first active—present in the form of fine particles—the second active can be present solubilized in an organic liquid.

Solid formulations such as granules, powders or any other solid concentrates have the advantage that the pesticide can be formulated at a higher concentration, which provides the advantages of lower production and packaging costs.

Unfortunately, a large number of these organic compounds are amorphous materials resulting in processing difficulties, formulation instabilities and application unreliability due to caking and settling of the fine particles.

Thus, there is a constant need in the art to find novel co-crystales of pesticides which have modified physicochemical properties, if compared to the solid state modifications of the pure pesticides.

Pyrimethanil is known as a fungicide and described in DD-A 151 404.

Co-crystals of pyrimethanil are known in the art, e.g. co-crystals of pyrimethanil with dithianon (see WO2009/047043 A1).

Dithiine tetracorboxamide of the formula I is known as fungicide and described in WO 2010/043319.

WO 2011/029551 describes mixtures of pyrimethanil and dithiine tetracarboximide of the formula I which are synergistic. All biological experiments were conducted in a solution of the mixture in aceton and DMSO. After adding 1% of an emulgator the solution was mixed with water to the desired concentration. Suspension concentrates were not described in this document.

During the preparation of a suspension concentrate (SC) of pyrimethanil and dithiine tetracorboxamide of the formula I was observated that the concentrate solidified and is not stable.

Accordingly, it was an object of the present invention to provide a mixture of pyrimethanil and dithiine tetracorboxamide of the formula I in a form which permits the preparation of suspension concentrates which are convenient in the application and stable and/or do not undergo (re-)crystallization of the solids on formulation and/or storage.

This object has been solved by the provision of the novel co-crystals comprising
(I) pyrimethanil; and
(II) dithiine tetracarboximide of the formula (I)

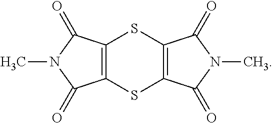 [SMILES: Cn1c(=O)c2sc3c(=O)n(C)c(=O)c3sc2c1=O]

Surprisingly, the complex according to the invention shows an increased melting point and a reduced solubility and reduced volatility compared to pyrimiethanil.

In the co-crystals according to the present invention, the molar ratio of pyrimethanil and dithiine tetracorboxamide of the formula I may vary from 2:1 to 1:2. In particular, the molar ratio is about 1:1, however, deviations are possible, though they will generally not exceed 20 mol-% and preferably 10 mol-%.

The co-crystal has typically a melting point in the range from 125 to 135° C. especially 131° C.

The co-crystals can be distinguished from simple mixture of pyrimethanil and dithiine tetracorboxamide of the formula I by standard analytical means used for the analysis of crystalline material, including X-ray powder diffractometry (PXRD), single crystal X-ray diffractometry (when single crystals of sufficient quality are available) and thermochemical analysis such as thermogravimetry (TGA) and differential scanning calorimetry (DSC) or by spectrometrical methods, such as solid state NMR (for example ¹³C CPMAS), FT-IR or Raman. Relative amounts of pyrimethanil and dithiine tetracorboxamide of the formula I can be determined e.g. by HPLC or by ¹H-NMR-spectroscopy.

Further details of each complex are set hereinbelow:

Co-crystal of pyrimethanil and dithiine tetracorboxamide of the formula I shows an X-ray powder diffractogram at 25° C. (Cu—Kα radiation, 1.54060 Å;) wherein the characteristic reflexes of the pure compounds are missing. In particular, the co-crystals of pyrimethanil and dithiine tetracorboxamide of the formula I shows at least 3, preferably at least 5, in particular at least 7 and more preferably all of the following reflexes, given in the following Table 1 as 2θ values or as lattice spacings d:

TABLE 1
PXRD of the co-crystal of cyprodinil and dithianon
(25° C., Cu-Kα-radiation, 1.54060 Å).

| 2θ values | d [Å] |
|---|---|
| 10.19 ± 0.2 | 8.68 ± 0.2 |
| 12.66 ± 0.2 | 6.99 ± 0.2 |
| 13.54 ± 0.2 | 6.54 ± 0.2 |
| 14.78 ± 0.2 | 5.99 ± 0.2 |
| 17.50 ± 0.2 | 5.07 ± 0.2 |
| 17.86 ± 0.2 | 4.97 ± 0.2 |
| 26.41 ± 0.2 | 3.37 ± 0.2 |
| 27.83 ± 0.2 | 3.21 ± 0.2 |

Thus, the present invention preferably relates to co-crystals of pyrimethanil and dithiine tetracorboxamide of the formula I, which, in a powder X-ray diffractogram at 25° C., show at least three, more preferably at least four, even more preferably at least six and in particular all of the following 2θ values [°]:

10.19 ± 0.2
12.66 ± 0.2
13.54 ± 0.2
14.78 ± 0.2
17.50 ± 0.2
17.86 ± 0.2
26.41 ± 0.2
27.83 ± 0.2

The present invention also comprises a process for preparing the co-crystals according to the invention, which comprises combining of pyrimethanil and dithiine tetracorboxamide of the formula I in suitable solvent.

In one embodiment of the present invention, hereinafter referred to as “Shear process” pyrimethanil and dithiine tetracorboxamide of the formula I are combined together by applying shear forces to pyrimethanil and dithiine tetracorboxamide of the formula I.

In a further embodiment of the present invention, hereinafter referred to as “Slurry process” pyrimethanil and dithiine tetracorboxamide of the formula I are in a suitable solvent.

In all of the preparation process variants, the respective liquid media used in the processes may also include additives which are usually present in agrochemical formulations, if appropriate. Suitable additives are described hereinafter and include surfactants, in particular anionic or nonionic emulsifiers, wetting agents and dispersants usually employed in crop protection compositions, furthermore antifoam agents, antifreeze agents, agents for adjusting the pH, stabilizers, anticaking agents, dyes and biocides (preservatives). The amount of the individual components will vary depending on the final formulation type. Examples of these auxiliaries are set forth here-inblow.

a) As set forth above, in the “Shear process”, the co-crystal is obtained by applying shear forces to the two components of the co-crystal.

In this process, pyrimethanil and dithiine tetracorboxamide of the formula I are combined in a suitable solvent provided, however, that pyrimethanil and dithiine tetracorboxamide of the formula I are not dissolved and still in the solid stage. Principally, it is also possible to combine pyrimethanil and dithiine tetracorboxamide of the formula I in a solid stage without any solvent and applying shear forces afterwards to the thus obtained solid mixture. Suspending in a suitable solvent is preferred.

Applying shear forces to the thus obtained suspension is preferably performed at a temperature of at least 15° C., frequently at a temperature of at least 20° C., preferably at a temperature of at least 30° C., in particular of at least 35° C. wherein the upper limit depends on the melting point of the pyrmethanil.

However, it is not necessary for pyrimethanil to be solid during the process and it might be advantageous if the temperature is close to or above the melting point of pyrimethanil. Upon applying shear forces to the liquid mixture at elevated temperatures the formation of the co-crystal might be accelerated.

The amount of the solvent in the suspension, which is obtained by combining pyrimethanil and dithiine tetracorboxamide of the formula I in the suitable solvent, is between 5 and 50-w %, preferably in between 5 and 30 w/w %, based on the total weight of the thus obtained suspension.

The suspension may contain pyrimethanil and dithiine tetracorboxamide of the formula I in a relative molar ratio varying from 1:5 to 20:1, preferably from 1:1.2 to 15:1. If one of the components is in excess with regard to the stoichiometry of the co-crystal, a mixture of the co-crystal and the compound being in excess will be obtained. For formulation purposes, the presence of an excess of pyrimethanil and dithiine tetracorboxamide of the formula I might be acceptable. In particular the presence of an excess of the co-former according to the present invention does not cause stability problems. However, it is preferred, that the amount of pyrimethanil in the aqueous suspension does not exceed more than 20 mol-% by weight, in particular not more than 10 mol-%, based on the amount of the co-former according to the present invention present in the mixture.

The time required for formation of the co-crystals depends in a manner known per se on the applied shear and the temperature and can be determined by the person skilled in the art in standard experiments. Times in the range of e.g. from 10 min. to 48 hours have been found to be suitable for formation of the co-crystal in the aqueous suspension containing pyrimethanil and dithiine tetracorboxamide of the formula I, although a longer period of time is also conceivable. A shearing time of 0.5 to 24 hours is preferred.

In a preferred embodiment, shear forces are applied to the aqueous suspension of pyrimethanil and dithiine tetracorboxamide of the formula I, which is obtained by combining pyrimethanil and dithiine tetracorboxamide of the formula I in the aqueous liquid. Shear forces can be applied by suitable techniques, which are capable of providing sufficient shear to bring the particles pyrimethanil and dithiine tetracorboxamide of the formula I into an intimate contact and/or to com-minute the particles of the co-crystals. Suitable techniques include grinding, crushing or milling, in particular by wet grinding or wet milling, including e.g. bead milling or by use of a colloid mill. Suitable shearing devices include in particular ball mills or bead mills, agitator ball mills, circulating mills (agitator ball mills with pin grinding system), disk mills, annular chamber mills, double cone mills, triple roll mills, batch mills, colloid mills, and media mills, such as sand mills. To dissipate the heat energy introduced during the grinding process, the grinding chambers are preferably fitted with cooling systems. Particularly suitable is the ball mill Drais Superflow DCP SF 12 from DRAISWERKE, INC. 40 Whitney Road. Mahwah, N.J. 07430 USA, a Drais Perl Mill PMC from DRAISWERKE, INC., the circulating mill system ZETA from Netzsch-Feinmahltechnik GmbH, the disk mill from Netzsch Feinmahltechnik GmbH, Selb, Germany, the bead mill Eiger Mini 50 from Eiger Machinery, Inc., 888 East Belvidere Rd., Grayslake, Ill. 60030 USA and the bead mill DYNO-Mill KDL from WA Bachofen AG, Switzerland. However, other homogenizers might also be suitable, including high shear stirrers, Ultra-Turrax apparatus, static mixers, e.g. systems having mixing nozzles and other homogenizers such as colloid mills.

In a preferred embodiment of the invention, shear forces are applied by bead milling. In particular, bead sizes in the range of from 0.05 to 5 mm, more particularly from 0.2 to 2.5 mm, and most particularly from 0.5 to 1.5 mm have been found to be suitable. In general, bead loadings in the range of from 40 to 99%, particularly from 70 to 97%, and more particularly from 65 to 95% may be used.

Preferred solvents for the Shear process are polar organic solvents or mixtures of water and at least one polar organic solvent for the slurry process are those, which are at least partially water miscible, i.e. which have miscibility with water of at least 10% v/v, more preferably at least 20% v/v at room temperature, mixtures thereof and mixtures of said water miscible solvents with organic solvents that have miscibility with water of less than 10% v/v at room temperature. Preferably the organic solvent comprises at least 80% v/v, based on the total amount of organic solvent, of the at least one water miscible solvent.

Suitable solvents having a water miscibility of at least 10% at room temperature include, but are not limited to the polar organic solvents as defined above.

More preference is given to organic solvents of the group 1, and to their mixtures with water. In the mixtures with water the relative amount of organic solvent and water may vary from 2:1 to 1:200 (v/v), in particular from 1:5 to 1:100 (v/v).

An especially suitable polar organic solvent to be used in mixture with water is an alcohol as mentioned above (C₁-C₄-alkanols such as methanol, ethanol, n-propanol or isopropanol).

An especially suitable polar organic solvent to be used in mixture with water is acetone.

b) In the Slurry process, the complex is obtained from a slurry of pyrimethanil and dithiine tetracorboxamide of the formula I in a solvent comprising an organic solvent or in particular from a slurry of pyrimethanil and dithiine tetracorboxamide of the formula I in a mixture of water and organic solvent. Consequently, this method comprises suspending pyrimethanil and dithiine tetracorboxamide of the formula I in an organic solvent or in a mixture of water and organic solvent.

Preferred organic solvents or mixtures of water and organic solvent for the slurry process are those, where pyrimethanil and dithiine tetracorboxamide of the formula I have a comparable solubility. Comparable solubility means that the solubilities of the individual compounds in the solvent or solvent system differ by a factor of not more than 20, in particular by a factor of not more than 10. It is, however, also possible to use a solvent or solvent system, wherein the solubilities of the individual compounds are not comparable. In this case, it might be preferable to use the compound having the higher solubility in the respective solvent or solvent system in excess.

Preferred solvents for the slurry process are those, which are at least partially water miscible, i.e. which have miscibility with water of at least 10% v/v, more preferably at least 20% v/v at room temperature, mixtures thereof and mixtures of said water miscible solvents with organic solvents that have miscibility with water of less than 10% v/v at room temperature. Preferably the organic solvent comprises at least 80% v/v, based on the total amount of organic solvent, of the at least one water miscible solvent.

Suitable solvents are polar organic solvents as defined above.

More preference is given to organic solvents of the group 1, and to their mixtures with water. In the mixtures with water the relative amount of organic solvent and water may vary from 2:1 to 1:200 (v/v), in particular from 1:5 to 1:100 (v/v).

An especially suitable organic solvent to be used in mixture with water is an acochol as mentioned above (C₁-C₄-alkanols such as methanol, ethanol, n-propanol or isopropanol) and acotone.

The slurry process can by simply performed by suspending pyrimethanil and dithiine tetracorboxamide of the formula I in the organic solvent or in a solvent/water mixture. The relative amounts of pyrimethanil and dithiine tetracorboxamide of the formula I and solvent or solvent/water mixture will be chosen to obtain a suspension at the given temperature. Complete dissolution of pyrimethanil and dithiine tetracorboxamide of the formula I should be avoided. In particular, pyrimethanil and dithiine tetracorboxamide of the formula I are suspended in an amount from 1 to 500 g, more preferably 10 to 400 g per litre of solvent or solvent/water mixture.

The relative molar amount of pyrimethanil and dithiine tetracorboxamide of the formula I in the slurry process may vary from 1:100 to 100:1, preferably from 1:10 to 10:1, depending on the relative solubilities of pyrimethanil and dithiine tetracorboxamide of the formula I in the chosen solvent or solvent system. In solvent systems where the solubilities of pyrimethanil and dithiine tetracorboxamide of the formula I are comparable the preferred molar ratio is from 2:1 to 1:2, in particular from 1.5:1 to 1:1.5 and especially about 1:1 (i.e. from 1.1:1 to 1:1.1). An excess of pyrimethanil will be used in solvent systems where pyrimethanil has a higher solubility. This applies also vice versa with dithiine tetracorboxamide of the formula I. If one of the components is in excess with regard to the stoichiometry of the co-crystal, a mixture of the co-crystal and the compound being in excess might be obtained, though an excess might also remain dissolved in the mother liquor, in particular if the compound which is used in excess has a high solubility in the chosen solvent system. For formulation purposes, the presence of an excess of pyrimethanil and dithiine tetracorboxamide of the formula I might be acceptable. In particular the presence of an excess of the co-former according to the present invention does not cause stability problems. For preparing the pure co-crystal, pyrimethanil and dithiine tetracorboxamide of the formula I will be used in a relative molar amount which is close to the stoichiometry of the complex to be formed and which usually will not deviate more than 50 mol.-%, based on the stoichiometrically required amount.

The slurry process is usually performed at a temperature of at least 5° C., preferably at least 10° C. and in particular at least 20° C., e.g. from 5 to 80° C., preferably from 10 to 55° C., in particular from 20 to 40° C.

The time required for formation of the co-crystal by the slurry process depends on the temperature, the type of solvent and is generally 1 h. In any case, complete conversion is achieved after one week, however, the complete conversion will usually require not more than 24 h.

According to one embodiment of the invention the slurry process is performed in the presence of co-crystals of pyrimethanil and dithiine tetracorboxamide of the formula I as seeding crystals. Usually 0.01 to 10% by weight, preferably 0.1 to 5% and more preferably 0.3 to 2% by weight of seeding crystals are employed based on the combined weight of pyrimethanil and dithiine tetracorboxamide of the formula I.

As already mentioned above, the co-crystal as defined herein are suitable for preparing crop protection compositions based on solid pesticides, such as aqueous suspension concentrates (SC, FS), suspo-emulsions (SE) and water dispersable granules (WG), water-dispersible powders (WP, WS), Dustable powders (DP, DS), granules (GR, FG, GG, MG), Dispersible concentrates (DC) and in particular for preparing a SC, FS, SE or WG formulation, capsule suspension (CS) and capsule suspension for seed treatment (CF), mixed formulation of capsule and suspension concentrate (ZC), mixed formulation of capsule and suspoemulsion (ZE).

Accordingly, the invention also provides an agricultural composition for crop protection, comprising the inventive co-crystals and if appropriate, further customary formulation auxiliaries.

The term formulation auxiliaries includes, but is not limited to liquid and solid carriers and further auxiliaries such as surfactants (adjuvants, wetting agents, tackifiers, dispersants or emulsifiers), furthermore viscosity-modifying additives (thickeners), antifoam agents, antifreeze agents, agents for adjusting the pH, stabilizers, anticaking agents and biocides (preservatives). Further auxiliaries suitable for seed treatment formulations comprise colorants and stickers.

The weight ratios of formulation auxiliaries and the respective co-crystal lie in ranges typically used for the respective solid formulation and the SE or SC formulation.

For example, in SCs and SEs, the amount of the co-crystal and, if appropriate, further active compounds is usually in the range from 5 to 70% by weight, in particular in the range from 10 to 50% by weight, based on the total weight of the suspension concentrate or suspo-emulsion.

In the other solid formulations (WG, WP, WS, DP, DS, GR, FG, GG, MG, DC), the amount of the co-crystal and, if appropriate, further active compounds is usually in the range from 10 to 90% by weight, in particular in the range from 15 to 70% by weight, based on the total weight of the solid formulation.

The total amount of formulation auxiliaries depends on the type of formulation used. Generally, it varies from 10 to 90% by weight, in particular from 85 to 30% by weight based on the total weight of the formulation.

The amount of surfactants varies depending on the formulation type. Usually, it is in the range from 0.1 to 20% by weight, in particular from 0.2 to 15% by weight and particularly preferably from 0.5 to 10% by weight based on the total weight of the formulation.

The amount of carriers (liquid or solid) varies depending on the formulation type. Usually, it is in the range from 1 to 90% by weight, in particular from 10 to 60% by weight and particularly preferably from 15 to 50% by weight based on the total weight of the formulation.

The amount of stickers will usually not exceed 40% by weight of the formulation and preferably ranges from 1 to 40% by weight, and in particular in the range from 5 to 30% by weight, based on the total weight of the formulation.

The amount of the remaining formulation auxiliaries (viscosity-modifying additives (thickeners), antifoam agents, antifreeze agents, agents for adjusting the pH, stabilizers, anticaking agents and biocides (preservatives), colorants, varies depending on the formulation type. Usually, it is in the range from 0.1 to 60% by weight, in particular from 0.5 to 40% by weight and particularly preferably from 1 to 20% by weight based on the total weight of the formulation.

Suitable liquid carriers are water, optionally containing water-miscible organic solvents, such as those of groups 1 to 10, and also organic solvents in which the co-crystal I or II or II has low or no solubility, for example those in which the solubility of the co-crystal I or II or III has at 25° C. and 1013 mbar are not more than 1% by weight, in particular not more than 0.5% by weight and especially not more than 0.1% by weight.

Examples of solvents (particulary usefull for SE formulations) are organic solvents such as mineral oil fractions of medium to high boiling point, such as kerosene or diesel oil, furthermore coal tar oils and oils of vegetable or animal origin, aliphatic, cyclic and aromatic hydrocarbons, e. g. toluene, xylene, paraffin, tetrahydronaphthalene, terpenes (including, but not limited to d-limonene) alkylated naphthalenes or their derivatives, linear and branched alcohols such as propanol, butanol, cyclohexanol, 2-phenoxyethanol, dodecylphenol, benzylalkohol, glycols, ketones such as cyclohexanone, 2-heptanone, acetophenone, 4-methoxyacetophenone, methylisoamylketone, methylisobutylketone, fatty acid dimethylamides, fatty acids and fatty acid esters and amides, esters such as 2-ethylhexyl acetate, 2-ethylhexyl-2 hydroxypropionate, butylene carbonate, isobornyl acetate, dimethyl succinate, dimethyl adipate, dimethyl glutarate, diisobutyl succinate, diisobutyl adipate, diisobutyl glutarate (and also mixtures of esters, e.g. mixtures of dimethyl succinate, dimethyl adipate, dimethyl glutarate, e.g. commercially available as Rhodiasolv RPDE; or mixtures of diisobutyl succinate, diisobutyl adipate, diisobutyl glutarate e.g. commercially available as Rhodiasolv RPDE Rhodiasolv DIB),-and strongly polar solvents, e. g. amines such as N-octylpyrrolidon and mixtures thereof.

Suitable solid carriers are, in principle, all solid substances usually used in crop protection compositions, in particular in fungicides. Solid carriers are, for example, e.g. silicates, silica gels, talc, kaolins, limestone, lime, chalk, clays, dolomite, diatomaceous earth, bentonite, calcium sulfate, magnesium sulfate, magnesium oxide; polysaccharide powders, e.g. cellulose, starch; fertilizers, e.g. ammonium sulfate, ammonium phosphate, ammonium nitrate, ureas; products of vegetable origin, e.g. cereal meal, tree bark meal, wood meal, nutshell meal, and mixtures thereof.

Suitable surfactants are surface-active compounds, such as anionic, cationic, nonionic and amphoteric surfactants, block polymers, polyelectrolytes, and mixtures thereof. Such surfactants can be used as emulsifier, dispersant, solubilizer, wetter, penetration enhancer, protective colloid, or adjuvant. Examples of surfactants are listed in McCutcheon's, Vol. 1: Emulsifiers & Detergents, McCutcheon's Directories, Glen Rock, USA, 2008 (International Ed. or North American Ed.).

Suitable anionic surfactants are alkali, alkaline earth or ammonium salts of sulfonates, sulfates, phosphates, carboxylates, and mixtures thereof. Examples of sulfonates are alkylarylsulfonates, diphenylsulfonates, alpha-olefin sulfonates, lignine sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkylnaphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates, and carboxylated alcohol or alkylphenol ethoxylates.

Suitable nonionic surfactants are alkoxylates, N-substituted fatty acid amides, amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation, preferably ethylene oxide. Examples of N-substituted fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides. Examples of polymeric surfactants are home- or copolymers of vinylpyrrolidone, vinylalcohols, or vinylacetate.

Suitable cationic surfactants are quaternary surfactants, for example quaternary ammonium compounds with one or two hydrophobic groups, or salts of long-chain primary amines. Suitable amphoteric surfactants are alkylbetains and imidazolines. Suitable block polymers are block polymers of the A-B or A-B-A type comprising blocks of polyethylene oxide and polypropylene oxide, or of the A-B-C type comprising alkanol, polyethylene oxide and polypropylene oxide. Suitable polyelectrolytes are polyacids or polybases. Examples of polyacids are alkali salts of polyacrylic acid or polyacid comb polymers. Examples of polybases are polyvinylamines or polyethyleneamines.

Suitable adjuvants are compounds, which have a neglectable or even no pesticidal activity themselves, and which improve the biological performance of the compound I on the target. Examples are surfactants, mineral or vegetable oils, and other auxilaries. Further examples are listed by Knowles, Adjuvants and additives, Agrow Reports DS256, T&F Informa UK, 2006, chapter 5.

Suitable thickeners are polysaccharides (e.g. xanthan gum, carboxymethylcellulose), anorganic clays (organically modified or unmodified), polycarboxylates, and silicates.

Suitable bactericides are bronopol and isothiazolinone derivatives such as alkylisothiazolinones and benzisothiazolinones.

Suitable anti-freezing agents are ethylene glycol, propylene glycol, urea and glycerin.

Suitable anti-foaming agents are silicones, long chain alcohols, and salts of fatty acids.

Suitable colorants (e.g. in red, blue, or green) are pigments of low water solubility and water-soluble dyes. Examples are inorganic colorants (e.g. iron oxide, titan oxide, iron hexacyanoferrate) and organic colorants (e.g. alizarin-, azo- and phthalocyanine colorants).

Suitable tackifiers or binders are polyvinylpyrrolidons, polyvinylacetates, polyvinyl alcohols, polyacrylates, biological or synthetic waxes, and cellulose ethers.

If appropriate, the water dispersable granules (WG), water-dispersible powders (WP, WS), Dustable powders (DP, DS), granules (GR, FG, GG, MG), Dispersible concentrates (DC), in particular in the WG, SCs or SEs according to the invention may comprise buffers for regulating the pH. Examples of buffers are alkali metal salts of weak inorganic or organic acids, such as, for example, phosphoric acid, boric acid, acetic acid, propionic acid, citric acid, fumaric acid, tartaric acid, oxalic acid and succinic acid.

In general, the respective solid formulations, in particular the SC, SE or WG comprise the co-crystal in a finely divided particulate form. In SC- and SE-formulations the particles of the co-crystal are suspended in a liquid medium, preferably in an aqueous medium. In water dispersable granules (WG), water-dispersible powders (WP, WS), Dustable powders (DP, DS), granules (GR, FG, GG, MG), Dispersible concentrates (DC), in particular in the WG, the finely divided particles are loosely agglomerated into larger granules that disintegrate upon dilution in water and then lead to a suspension of these finely divided particles. The size of the active compound particles, i.e. the size which is not exceeded by 90% by weight of the active compound particles, is typically not more than 30 μm, preferably not more than 20 μm, in particular not more than 10 μm, especially not more than 5 μm, as determined by dynamic light scattering. Advantageously, at least 40% by weight and in particular at least 60% by weight of the particles in the SCs according to the invention have diameters below 2 μm.

The respective formulations can be prepared in a known manner such as described by Mollet and Grubemann, Formulation technology, Wiley VCH, Weinheim, 2001; or Knowles, New developments in crop protection product formulation, Agrow Reports DS243, T&F Informa, London, 2005.

For example, suspension concentrates, in particular aqueous suspension concentrates can be prepared by suspending the co-crystal in a suitable liquid carrier, which may contain conventional formulation additives as described hereinafter. However, it is preferred to prepare the suspension concentrate by the shear process as described herein, i.e. by applying shear forces to a liquid which contains suspended particles of pyrimethanil and dithiine tetracorboxamide of the formula I and optionally further additives until the co-crystal has been formed.

Suspo-emulsions can be prepared in accordance with the methods as described for SCs with the provisoe that a second pesticide (besides the co-crystal) can be added to the final SC or during preparation of the SC solubilised in a suitable organic solvent (optionally together with suitable further formulation auxiliaries).

Powders, materials for spreading and dustable products can be prepared by mixing or concomitantly grinding the co-crystal (and optionally a further pesticide) with a solid carrier.

Granules, for example coated granules, impregnated granules and homogeneous granules, can be prepared by binding the active compounds to solid carriers.

Powders, materials for spreading and dusts can be prepared by mixing or concomitantly grinding the compounds I and, if appropriate, further active substances, with at least one solid carrier.

Granules, e. g. coated granules, impregnated granules and homogeneous granules, can be prepared by binding the active substances to solid carriers.

The formulations as described above may also comprise further active compounds against pests. For example, insecticides or further herbicides or fungicides or else herbicidal or growth-regulating active compounds or fertilizers can be added as further active components according to need.

All embodiments of the formulations comprising at least one co-crystal are hereinbelow referred to as “agrochemical formulation”.

The present invention comprises a method for controlling pests, wherein the pest, their habitat, breeding grounds, their locus or the plants to be protected against such pests, the soil or plant propagation material are treated with an effective amount of the inventive co-crystal or with an agricultural formulation the inventive co-crystal.

The present invention furthermore comprises a method for improving the health of plants, wherein the plant, the locus where the plant is growing or is expected to grow or plant propagation material from which the plant grows are treated with an effective amount of the inventive co-crystal or with an agricultural formulation the inventive co-crystal.

The invention also relates to the propagation products of plants, and especially the seed comprising, that is, coated with and/or containing, with an effective amount of the inventive co-crystal or with an agricultural formulation the inventive co-crystal.

The plant propagation material (preferably seed) comprises the inventive mixtures in an amount of from 0.01 g to 10 kg per 100 kg of plant propagation material (preferably seed).

If the method is defined as a method of combating phytopathogenic pests or increasing the health of plants, wherein the pests, their habitat, breeding grounds, their locus or the plants to be protected or the soil; or the plant, the locus where the plant is growing or is expected to grow; are treated with an effective amount of the respective co-crystal or with an agricultural formulation comprising at the respective complex, the amounts of co-crystal is, depending on the kind of effect desired, from 0.001 to 2 kg per ha, preferably from 0.005 to 2 kg per ha, more preferably from 0.05 to 0.9 kg per ha, in particular from 0.1 to 0.75 kg per ha.

The term pest refers to animal pests from the following orders: insects from the order of the lepidopterans (Lepidoptera), for example Agrotis ypsilon, Agrotis segetum, Alabama argillacea, Anticarsia gemmatalis, Argyresthia conjugella, Autographa gamma, Bupalus piniarius, Cacoecia murinana, Capua reticulana, Cheimatobia brumata, Choristoneura fumiferana, Choristoneura occidentalis, Cirphis unipuncta, Cydia pomonella, Dendrolimus pini, Diaphania nitidalis, Diatraea grandiosella, Earias insulana, Elasmopalpus lignosellus, Eupoecilia ambiguella, Evetria bouliana, Feltia subterranea, Galleria mellonella, Grapholitha funebrana, Grapholitha molesta, Heliothis armigera, Heliothis virescens, Heliothis zea, Hellula undalis, Hibernia defoliana, Hyphantria cunea, Hyponomeuta malinellus, Keiferia lycopersicella, Lambdina fiscellaria, Laphygma exigua, Leucoptera coffeella, Leucoptera scitella, Lithocolletis blancardella, Lobesia botrana, Loxostege sticticalis, Lymantria dispar, Lymantria monacha, Lyonetia clerkella, Malacosoma neustria, Mamestra brassicae, Orgyia pseudotsugata, Ostrinia nubilalis, Panolis flammea, Pectinophora gossypiella, Peridroma saucia, Phalera bucephala, Phthorimaea operculella, Phyllocnistis citrella, Pieris brassicae, Plathypena scabra, Plutella xylostella, Pseudoplusia includens, Rhyacionia frustrana, Scrobipalpula absoluta, Sitotroga cerealella, Sparganothis pilleriana, Spodoptera frugiperda, Spodoptera littoralis, Spodoptera litura, Thaumatopoea pityocampa, Tortrix viridana, Trichoplusia ni and Zeiraphera canadensis,

beetles (Coleoptera), for example Agrilus sinuatus, Agriotes lineatus, Agriotes obscurus, Amphimallus solstitialis, Anisandrus dispar, Anthonomus grandis, Anthonomus pomorum, Aphthona euphoridae, Athous haemorrhoidalis, Atomaria linearis, Blastophagus piniperda, Blitophaga undata, Bruchus rufimanus, Bruchus pisorum, Bruchus lentis, Byctiscus betulae, Cassida nebulosa, Cerotoma trifurcata, Cetonia aurata, Ceuthorrhynchus assimilis, Ceuthorrhynchus napi, Chaetocnema tibialis, Conoderus vespertinus, Crioceris asparagi, Ctenicera ssp., Diabrotica longicornis, Diabrotica semipunctata, Diabrotica 12-punctata Diabrotica speciosa, Diabrotica virgifera, Epilachna varivestis, Epitrix hirtipennis, Eutinobothrus brasiliensis, Hylobius abietis, Hypera brunneipennis, Hypera postica, Ips typographus, Lema bilineata, Lema melanopus, Leptinotarsa decemlineata, Limonius californicus, Lissorhoptrus oryzophilus, Melanotus communis, Meligethes aeneus, Melolontha hippocastani, Melolontha melolontha, Oulema oryzae, Ortiorrhynchus sulcatus, Otiorrhynchus ovatus, Phaedon cochleariae, Phyllobius pyri, Phyllotreta chrysocephala, Phyllophaga sp., Phyllopertha horticola, Phyllotreta nemorum, Phyllotreta striolata, Popillia japonica, Sitona lineatus and Sitophilus granana,

flies, mosquitoes (Diptera), e.g. Aedes aegypti, Aedes albopictus, Aedes vexans, Anastrepha ludens, Anopheles maculipennis, Anopheles crucians, Anopheles albimanus, Anopheles gambiae, Anopheles freeborni, Anopheles leucosphyrus, Anopheles minimus, Anopheles quadrimaculatus, Calliphora vicina, Ceratitis capitata, Chrysomya bezziana, Chrysomya hominivorax, Chrysomya macellaria, Chrysops discalis, Chrysops silacea, Chrysops atlanticus, Cochliomyia hominivorax, Contarinia sorghicola Cordylobia anthropophaga, Culicoides furens, Culex pipiens, Culex nigripalpus, Culex quinquefasciatus, Culex tarsalis, Culiseta inornata, Culiseta melanura, Dacus cucurbitae, Dacus oleae, Dasineura brassicae, Delia antique, Delia coarctata, Delia platura, Delia radicum, Dermatobia hominis, Fannia canicularis, Geomyza Tripunctata, Gasterophilus intestinalis, Glossina morsitans, Glossina palpalis, Glossina fuscipes, Glossina tachinoides, Haematobia irritans, Haplodiplosis equestris, Hippelates spp., Hylemyia platura, Hypoderma lineata, Leptoconops torrens, Liriomyza sativae, Liriomyza trifolii, Lucilia caprina, Lucilia cuprina, Lucilia sericata, Lycoria pectoralis, Mansonia titillanus, Mayetiola destructor, Musca domestica, Muscina stabulans, Oestrus ovis, Opomyza florum, Oscinella frit, Pegomya hysocyami, Phorbia antiqua, Phorbia brassicae, Phorbia coarctata, Phlebotomus argentipes, Psorophora columbiae, Psila rosae, Psorophora discolor, Prosimulium mixtum, Rhagoletis cerasi, Rhagoletis pomonella, Sarcophaga haemorrhoidalis, Sarcophaga sp., Simulium vittatum, Stomoxys calcitrans, Tabanus bovinus, Tabanus atratus, Tabanus lineola, and Tabanus similis, Tipula oleracea, and Tipula paludosa

thrips (Thysanoptera), e.g. Dichromothrips corbetti, Dichromothrips ssp, Frankliniella fusca, Frankliniella occidentalis, Frankliniella tritici, Scirtothrips citri, Thrips oryzae, Thrips palmi and Thrips tabaci,

termites (Isoptera), e.g. Calotermes flavicollis, Leucotermes flavipes, Heterotermes aureus, Reticulitermes flavipes, Reticulitermes virginicus, Reticulitermes lucifugus, Termes natalensis, and Coptotermes formosanus,

cockroaches (Blattaria—Blattodea), e.g. Blattella germanica, Blattella asahinae, Periplaneta americana, Periplaneta japonica, Periplaneta brunnea, Periplaneta fuligginosa, Periplaneta australasiae, and Blatta orientalis,

true bugs (Hemiptera), e.g. Acrosternum hilare, Blissus leucopterus, Cyrtopeltis notatus, Dysdercus cingulatus, Dysdercus intermedius, Eurygaster integriceps, Euschistus impictiventris, Leptoglossus phyllopus, Lygus lineolaris, Lygus pratensis, Nezara viridula, Piesma quadrata, Solubea insularis, Thyanta perditor, Acyrthosiphon onobrychis, Adelges laricis, Aphidula nasturtii, Aphis fabae, Aphis forbesi, Aphis pomi, Aphis gossypii, Aphis grossulariae, Aphis schneideri; Aphis spiraecola, Aphis sambuci, Acyrthosiphon pisum, Aulacorthum solani, Bemisia argentifolii; Brachycaudus cardui, Brachycaudus helichrysi, Brachycaudus persicae, Brachycaudus prunicola, Brevicoryne brassicae, Capitophorus horni, Cerosipha gossypii, Chaetosiphon fragaefolii, Cryptomyzus ribis, Dreyfusia nordmannianae, Dreyfusia piceae, Dysaphis radicola, Dysaulacorthum pseudosolani, Dysaphis plantaginea, Dysaphis pyri, Empoasca fabae, Hyalopterus pruni, Hyperomyzus lactucae, Macrosiphum avenae, Macrosiphum euphorbiae, Macrosiphon rosae, Megoura viciae, Melanaphis pyrarius, Metopolophium dirhodum, Myzus persicae, Myzus ascalonicus, Myzus cerasi, Myzus varians, Nasonovia ribis-nigri, Nilaparvata lugens, Pemphigus bursarius, Perkinsiella saccharicida, Phorodon humuli, Psylla mali, Psylla piri, Rhopalomyzus ascalonicus, Rhopalosiphum maidis, Rhopalosiphum padi, Rhopalosiphum insertum, Sappaphis mala, Sappaphis mali, Schizaphis graminum, Schizoneura lanuginosa, Sitobion avenae, Trialeurodes vaporariorum, Toxoptera aurantii and, Viteus vitifolii, Cimex lectularius, Cimex hemipterus, Reduvius senilis, Triatoma spp., and Arilus critatus.

ants, bees, wasps, sawflies (Hymenoptera), e.g. Athalia rosae, Atta cephalotes, Atta capiguara, Atta cephalotes, Atta laevigata, Atta robusta, Atta sexdens, Atta texana, Crematogaster spp., Hoplocampa minuta, Hoplocampa testudinea, Monomorium pharaonis, Solenopsis geminata, Solenopsis invicta, Solenopsis richteri, Solenopsis xyloni, Pogonomyrmex barbatus, Pogonomyrmex californicus, Pheidole megacephala, Dasymutilla occidentalis, Bombus spp. Vespula squamosa, Paravespula vulgaris, Paravespula pennsylvanica, Paravespula germanica, Dolichovespula maculata, Vespa crabro, Polistes rubiginosa, Camponotus floridanus, and Linepithema humile,

crickets, grasshoppers, locusts (Orthoptera), e.g. Acheta domestica, Gryllotalpa gryllotalpa, Locusta migratoria, Melanoplus bivittatus, Melanoplus femurrubrum, Melanoplus mexicanus, Melanoplus sanguinipes, Melanoplus spretus, Nomadacris septemfasciata, Schistocerca americana, Schistocerca gregaria, Dociostaurus maroccanus, Tachycines asynamorus, Oedaleus senegalensis, Zonozerus variegatus, Hieroglyphus daganensis, Kraussaria angulifera, Calliptamus italicus, Chortoicetes terminifera, and Locustana pardalina,

Arachnoidea, such as arachnids (Acarina), e.g. of the families Argasidae, Ixodidae and Sarcoptidae, such as Amblyomma americanum, Amblyomma variegatum, Ambryomma maculatum, Argas persicus, Boophilus annulatus, Boophilus decoloratus, Boophilus microplus, Dermacentor silvarum, Dermacentor andersoni, Dermacentor variabilis, Hyalomma truncatum, Ixodes ricinus, Ixodes rubicundus, Ixodes scapularis, Ixodes holocyclus, Ixodes pacificus, Ornithodorus moubata, Ornithodorus hermsi, Ornithodorus turicata, Ornithonyssus bacoti, Otobius megnini, Dermanyssus gallinae, Psoroptes ovis, Rhipicephalus sanguineus, Rhipicephalus appendiculatus, Rhipicephalus evertsi, Sarcoptes scabiei, and Eriophyidae spp. such as Aculus schlechtendali, Phyllocoptrata oleivora and Eriophyes sheldoni; Tarsonemidae spp. such as Phytonemus pallidus and Polyphagotarsonemus latus; Tenuipalpdae spp. such as Brevipalpus phoenicis; Tetranychidae spp. such as Tetranychus cinnabarinus, Tetranychus kanzawai, Tetranychus pacificus, Tetranychus telarius and Tetranychus urticae, Panonychus ulmi, Panonychus citri, and Oligonychus pratensis; Araneida, e.g. Latrodectus mactans, and Loxosceles reclusa,

fleas (Siphonaptera), e.g. Ctenocephalides felis, Ctenocephalides canis, Xenopsylla cheopis, Pulex irritans, Tunga penetrans, and Nosopsyllus fasciatus,

silverfish, firebrat (Thysanura), e.g. Lepisma saccharina and Thermobia domestica,

centipedes (Chilopoda), e.g. Scutigera coleoptrata,

millipedes (Diplopoda), e.g. Narceus spp.,

Earwigs (Dermaptera), e.g. forficula auricularia,

lice (Phthiraptera), e.g. Pediculus humanus capitis, Pediculus humanus corporis, Pthirus pubis, Haematopinus eurysternus, Haematopinus suis, Linognathus vituli, Bovicola bovis, Menopon gallinae, Menacanthus stramineus and Solenopotes capillatus,

plant parasitic nematodes such as root-knot nematodes, Meloidogyne arenaria, Meloidogyne chitwoodi, Meloidogyne exigua, Meloidogyne hapla, Meloidogyne incognita, Meloidogyne javanica and other Meloidogyne species; cyst nematodes, Globodera rostochiensis, Globodera pallida, Globodera tabacum and other Globodera species, Heterodera avenae, Heterodera glycines, Heterodera schachtii, Heterodera trifolii, and other Heterodera species; seed gall nematodes, Anguina funesta, Anguina tritici and other Anguina species; stem and foliar nematodes, Aphelenchoides besseyi, Aphelenchoides fragariae, Aphelenchodes ritzemabosi and other Aphelenchoides species; sting nematodes, Belonolaimus longicaudatus and other Belonolaimus species; pine nematodes, Bursaphelenchus xylophilus and other Bursaphelenchus species; ring nematodes, Criconema species, Criconemella species, Criconemoides species, and Mesocriconema species; stem and bulb nematodes, Ditylenchus destructor, Ditylenchus dipsaci, Ditylenchus myceliophagus and other Ditylenchus species; awl nematodes, Dolichodorus species; spiral nematodes, Helicotylenchus dihystera, Helicotylenchus multicinctus and other Helicotylenchus species, Rotylenchus robustus and other Rotylenchus species, sheath nematodes, Hemicycliophora species and Hemicriconemoides species; Hirshmanniella species; lance nematodes, Hoplolaimus columbus, Hoplolaimus galeatus and other Hoplolaimus species; false root-knot nematodes, Nacobbus aberrans and other Nacobbus species; needle nematodes, Longidorus elongates and other Longidorus species; pin nematodes, Paratylenchus species; lesion nematodes, Pratylenchus brachyurus, Pratylenchus coffeae, Pratylenchus curvitatus, Pratylenchus goodeyi, Pratylencus neglectus, Pratylenchus penetrans, Pratylenchus scribneri, Pratylenchus vulnus, Pratylenchus zeae and other Pratylenchus species; Radinaphelenchus cocophilus and other Radinaphelenchus species, burrowing nematodes, Radopholus similis and other Radopholus species; reniform nematodes, Rotylenchulus reniformis and other Rotylenchulus species; Scutellonema species; stubby root nematodes, Trichodorus primitivus and other Trichodorus species; Paratrichodorus minor and other Paratrichodorus species; stunt nematodes, Tylenchorhynchus claytoni, Tylenchorhynchus dubius and other Tylenchorhynchus species and Merlinius species; citrus nematodes, Tylenchulus semipenetrans and other Tylenchulus species; dagger nematodes, Xiphinema americanum, Xiphinema index, Xiphinema diversicaudatum and other Xiphinema species; and other plant parasitic nematode species.

The present invention furthermore comprises a method of improving the health of plants, which comprises applying the inventive co-crystal or an effective amount of an agrochemical formulation of the inventive co-crystal to plants, parts of plants, plant propagation material or the locus where plants grow.

Herein, the amounts of co-crystal is, depending on the kind of effect desired, from 0.001 to 2 kg per ha, preferably from 0.005 to 2 kg per ha, more preferably from 0.05 to 0.9 kg per ha, in particular from 0.1 to 0.75 kg per ha.

The term “plant health” is to be understood to denote a condition of the plant and/or its products which is determined by several indicators alone or in combination with each other such as yield (e. g. increased biomass and/or increased content of valuable ingredients), plant vigor (e. g. improved plant growth and/or greener leaves (“greening effect”)), quality (e. g. improved content or composition of certain ingredients) and tolerance to abiotic and/or biotic stress. The above identified indicators for the health condition of a plant may be interdependent or may result from each other.

Generally the term “plants” also includes plants which have been modified by breeding, mutagenesis or genetic engineering (transgenic and non-transgenic plants). Genetically modified plants are plants, which genetic material has been modified by the use of recombinant DNA techniques in a way that it cannot readily be obtained by cross breeding under natural circumstances, mutations or natural recombination.

Plants and as well as the propagation material of said plants, which can be treated with the inventive co-crystal include all modified non-transgenic plants or transgenic plants, e.g. crops which tolerate the action of herbicides or fungicides or insecticides owing to breeding, including genetic engineering methods, or plants which have modified characteristics in comparison with existing plants, which can be generated for example by traditional breeding methods and/or the generation of mutants, or by recombinant procedures.

For example, the inventive co-crystal can be applied in accordance with the methods of treatment as set forth above also to plants which have been modified by breeding, mutagenesis or genetic engineering including but not limiting to agricultural biotech products on the market or in development (cf. http://www.bio.org/speeches/pubs/er/agri_products.asp). Genetically modified plants are plants, which genetic material has been so modified by the use of recombinant DNA techniques that under natural circumstances cannot readily be obtained by cross breeding, mutations or natural recombination. Typically, one or more genes have been integrated into the genetic material of a genetically modified plant in order to improve certain properties of the plant. Such genetic modifications also include but are not limited to targeted post-transitional modification of protein(s), oligo- or polypeptides e.g. by glycosylation or polymer additions such as prenylated, acetylated or farnesylated moieties or PEG moieties.

Plants that have been modified by breeding, mutagenesis or genetic engineering, e.g. have been rendered tolerant to applications of specific classes of herbicides. Tolerance to herbicides can be obtained by creating insensitivity at the site of action of the herbicide by expression of a target enzyme which is resistant to herbicide; rapid metabolism (conjugation or degradation) of the herbicide by expression of enzymes which inactivate herbicide; or poor uptake and translocation of the herbicide. Examples are the expression of enzymes which are tolerant to the herbicide in comparison to wild type enzymes, such as the expression of 5-enolpyruvylshikimate-3-phosphate synthase (EPSPS), which is tolerant to glyphosate (see e.g. Heck et. al, Crop Sci. 45, 2005, 329-339; Funke et. al, PNAS 103, 2006, 13010-13015; U.S. Pat. No. 5,188,642, U.S. Pat. No. 4,940,835, U.S. Pat. No. 5,633,435, U.S. Pat. No. 5,804,425, U.S. Pat. No. 5,627,061), the expression of glutamine synthase which is tolerant to glufosinate and bialaphos (see e.g. U.S. Pat. No. 5,646,024, U.S. Pat No. 5,561,236) and DNA constructs coding for dicamba-degrading enzymes (see for general reference US 2009/0105077, e.g. U.S. Pat No. 7,105,724 for dicamba resistance in bean, maize (for maize see also WO2008051633), cotton (for cotton see also U.S. Pat No. 5,670,454), pea, potatoe, sorghum, soybean (for soybean see also U.S. Pat No. 5,670,454), sunflower, tobacco, tomato (for tomato see also U.S. Pat No. 5,670,454)).

Furthermore, this comprises also plants tolerant to applications of imidazolinone herbicides (canola (Tan et. al, Pest Manag. Sci 61, 246-257 (2005)); maize (U.S. Pat No. 4,761,373, U.S. Pat No. 5,304,732, U.S. Pat No. 5,331,107, U.S. Pat No. 5,718,079, U.S. Pat No. 6,211,438, U.S. Pat No. 6,211,439 and U.S. Pat No. 6,222,100, Tan et. al, Pest Manag. Sci 61, 246-257 (2005)); rice (U.S. Pat No. 4,761,373, U.S. Pat No. 5,304,732, U.S. Pat No. 5,331,107, U.S. Pat No. 5,718,079, U.S. Pat No. 6,211,438, U.S. Pat No. 6,211,439 and U.S. Pat No. 6,222,100, S653N (see e.g. US 2003/0217381), S654K (see e.g. US 2003/0217381), A122T (see e.g. WO 04/106529) S653 (At)N, S654 (At)K, A122 (At)T and other resistant rice plants as described in WO0027182, WO 05/20673 and WO0185970 or U.S. Pat No. 5,545,822, U.S. Pat No. 5,736,629, U.S. Pat No. 5,773,703, U.S. Pat No. 5,773,704, U.S. Pat No.-5,952,553, U.S. Pat No. 6,274,796); millet (U.S. Pat No. 4,761,373, U.S. Pat No. 5,304,732, U.S. Pat No. 5,331,107, U.S. Pat No. 5,718,079, U.S. Pat No. 6,211,438, U.S. Pat No. 6,211,439 and U.S. Pat No. 6,222,100); barley (U.S. Pat No. 4,761,373, U.S. Pat No. 5,304,732, U.S. Pat No. 5,331,107, U.S. Pat No. 5,718,079, U.S. Pat No. 6,211,438, U.S. Pat No. 6,211,439 and U.S. Pat No. 6,222,100); wheat (U.S. Pat No. 4,761,373, U.S. Pat No. 5,304,732, U.S. Pat No. 5,331,107, U.S. Pat No. 5,718,079, U.S. Pat No. 6,211,438, U.S. Pat No. 6,211,439, U.S. Pat No. 6,222,100, WO 04/106529, WO 04/16073, WO 03/14357, WO 03/13225 and WO 03/14356); sorghum (U.S. Pat No. 4,761,373, U.S. Pat No. 5,304,732, U.S. Pat No. 5,331,107, U.S. Pat No. 5,718,079, U.S. Pat No. 6,211,438, U.S. Pat No. 6,211,439 and U.S. Pat No. 6,222,100); oats (U.S. Pat No. 4,761,373, U.S. Pat No. 5,304,732, U.S. Pat No. 5,331,107, U.S. Pat No. 5,718,079, U.S. Pat No. 6,211,438, U.S. Pat No. 6,211,439 and U.S. Pat No. 6,222,100); rye (U.S. Pat No. 4,761,373, U.S. Pat No. 5,304,732, U.S. Pat No. 5,331,107, U.S. Pat No. 5,718,079, U.S. Pat No. 6,211,438, U.S. Pat No. 6,211,439 and U.S. Pat No. 6,222,100); sugar beet (WO9802526/WO9802527); lentils (US2004/0187178); sunflowers (Tan et. al, Pest Manag. Sci 61, 246-257 (2005))). Gene constructs can be obtained, for example, from micro-organism or plants, which are tolerant to said herbicides, such as the Agrobacterium strain CP4 EPSPS which is resistant to glyphosate; Streptomyces bacteria which are resistance to glufosinate; Arabidopsis, Daucus carotte, Pseudomonoas sp. or Zea mais with chimeric gene sequences coding for HDDP (see e.g. WO1996/38567, WO 2004/55191); Arabidopsis thaliana which is resistant to protox inhibitors (see e.g. US2002/0073443).

Examples of commercial available plants with tolerance to herbicides, are the corn varieties “Roundup Ready Corn”, “Roundup Ready 2” (Monsanto), “Agrisure GT”, “Agrisure GT/CB/LL”, “Agrisure GT/RW”, “Agrisure 3000GT” (Syngenta), “YieldGard VT Rootworm/RR2” and “YieldGard VT Triple” (Monsanto) with tolerance to glyphosate; the corn varieties “Liberty Link” (Bayer), “Herculex I”, “Herculex RW”, “Herculex Xtra” (Dow, Pioneer), “Agrisure GT/CB/LL” and “Agrisure CB/LL/RW” (Syngenta) with tolerance to glufosinate; the soybean varieties “Roundup Ready Soybean” (Monsanto) and “Optimum GAT” (DuPont, Pioneer) with tolerance to glyphosate; the cotton varieties “Roundup Ready Cotton” and “Roundup Ready Flex” (Monsanto) with tolerance to glyphosate; the cotton variety “FiberMax Liberty Link” (Bayer) with tolerance to glufosinate; the cotton variety “BXN” (Calgene) with tolerance to bromoxynil; the canola varieties, “Navigator” und “Compass” (Rhone-Poulenc) with bromoxynil tolerance; the canola variety “Roundup Ready Canola” (Monsanto) with glyphosate tolerance; the canola variety “In-Vigor” (Bayer) with glufosinate tolerance; the rice variety “Liberty Link Rice” (Bayer) with glulfosinate tolerance and the alfalfa variety “Roundup Ready Alfalfa” with glyphosate tolerance. Further modified plants with herbicide are commonly known, for instance alfalfa, apple, eucalyptus, flax, grape, lentils, oil seed rape, peas, potato, rice, sugar beet, sunflower, tobacco, tomatom turf grass and wheat with tolerance to glyphosate (see e.g. U.S. Pat No. 5,188,642, U.S. Pat No. 4,940,835, U.S. Pat No. 5,633,435, U.S. Pat No. 5,804,425, U.S. Pat No. 5,627,061); beans, soybean, cotton, peas, potato, sunflower, tomato, tobacco, corn, sorghum and sugarcane with tolerance to dicamba (see e.g. US 2009/0105077, U.S. Pat No. 7,105,724 and U.S. Pat No. 5,670,454); pepper, apple, tomato, hirse, sunflower, tobacco, potato, corn, cucumber, wheat, soybean and sorghum with tolerance to 2,4-D (see e.g. U.S. Pat No. 6,153,401, U.S. Pat No. 6,100,446, WO2005107437, U.S. Pat No. 5,608,147 and U.S. Pat No. 5,670,454); sugarbeet, potato, tomato and tobacco with tolerance to gluphosinate (see e.g. U.S. Pat No. 5,646,024, U.S. Pat No. 5,561,236); canola, barley, cotton, juncea, lettuce, lentils, melon, millet, oats, oilseed rapre, potato, rice, rye, sorghum, soybean, sugarbeet, sunflower, tobacco, tomato and wheat with tolerance to acetolactate synthase (ALS) inhibiting herbicides, such as triazolopyrimidine sulfonamides, growth inhibitors and imidazolinones (see e.g. U.S. Pat No. 5,013,659, WO2006060634, U.S. Pat No. 4,761,373, U.S. Pat No. 5,304,732, U.S. Pat No. 6,211,438, U.S. Pat No. 6,211,439 and U.S. Pat No. 6,222,100); cereal, sugar cane, rice, corn, tobacco, soybean, cotton, rapeseed, sugar beet and potato with tolerance to HPPD inhibitor herbicides (see e.g. WO2004/055191, WO199638567, WO1997049816 and U.S. Pat No. 6,791,014); wheat, soybean, cotton, sugar beet, rape, rice, corn, sorghum and sugar cane with tolerance to protoporphyrinogen oxidase (PPO) inhibitor herbicides (see e.g. US2002/0073443, US20080052798, Pest Management Science, 61, 2005, 277-285). The methods of producing such herbicide resistant plants are generally known to the person skilled in the art and are described, for example, in the publications mentioned above.

Further examples of commercial available modified plants with tolerance to herbicides “CLEARFIELD Corn”, “CLEARFIELD Canola”, “CLEARFIELD Rice”, “CLEARFIELD Lentils”, “CLEARFIELD Sunflowers” (BASF) with tolerance to the imidazolinone herbicides.

Furthermore, plants are also covered that are by the use of recombinant DNA techniques capable to synthesize one or more insecticidal proteins, especially those known from the bacterial genus Bacillus, particularly from Bacillus thuringiensis, such as δ-endotoxins, e.g. CryIA(b), CryIA(c), CryIF, CryIF(a2), CryIIA(b), CryIIIA, CryIIIB(b1) or Cry9c; vegetative insecticidal proteins (VIP), e.g. VIP1, VIP2, VIP3 or VIP3A; insecticidal proteins of bacteria colonizing nematodes, e.g. Photorhabdus spp. or Xenorhabdus spp.; toxins produced by animals, such as scorpion toxins, arachnid toxins, wasp toxins, or other insect-specific neurotoxins; toxins produced by fungi, such Streptomycetes toxins, plant lectins, such as pea or barley lectins; agglutinins; proteinase inhibitors, such as trypsin inhibitors, serine protease inhibitors, patatin, cystatin or papain inhibitors; ribosome-inactivating proteins (RIP), such as ricin, maize-RIP, abrin, luffin, saporin or bryodin; steroid metabolism enzymes, such as 3-hydroxysteroid oxidase, ecdysteroid-IDP-glycosyl-transferase, cholesterol oxidases, ecdysone inhibitors or HMG-CoA-reductase; ion channel blockers, such as blockers of sodium or calcium channels; juvenile hormone esterase; diuretic hormone receptors (helicokinin receptors); stilben synthase, bibenzyl synthase, chitinases or glucanases. In the context of the present invention these insecticidal proteins or toxins are to be understood expressly also as pre-toxins, hybrid proteins, truncated or otherwise modified proteins. Hybrid proteins are characterized by a new combination of protein domains, (see, e.g. WO 02/015701). Further examples of such toxins or genetically modified plants capable of synthesizing such toxins are disclosed, e.g., in EP-A 374 753, WO 93/007278, WO 95/34656, EP-A 427 529, EP-A 451 878, WO 03/18810 und WO 03/52073. The methods for producing such genetically modified plants are generally known to the person skilled in the art and are described, e.g. in the publications mentioned above. These insecticidal proteins contained in the genetically modified plants impart to the plants producing these proteins tolerance to harmful pests from all taxonomic groups of athropods, especially to beetles (Coeloptera), two-winged insects (Diptera), and moths (Lepidoptera) and to nematodes (Nematoda). Genetically modified plants capable to synthesize one or more insecticidal proteins are, e.g., described in the publications mentioned above, and some of which are commercially available such as YieldGard® (corn cultivars producing the Cry1Ab toxin), YieldGard® Plus (corn cultivars producing Cry1Ab and Cry3Bb1 toxins), Starlink® (corn cultivars producing the Cry9c toxin), Herculex® RW (corn cultivars producing Cry34Ab1, Cry35Ab1 and the enzyme Phosphinothricin-N-Acetyltransferase [PAT]); NuCOTN® 33B (cotton cultivars producing the Cry1Ac toxin), Bollgard® I (cotton cultivars producing the Cry1Ac toxin), Bollgard® II (cotton cultivars producing Cry1Ac and Cry2Ab2 toxins); VIPCOT® (cotton cultivars producing a VIP-toxin); New-Leaf® (potato cultivars producing the Cry3A toxin); Bt-Xtra®, NatureGard®, KnockOut®, BiteGard®, Protecta®, Bt11 (e.g. Agrisure® CB) and Bt176 from Syngenta Seeds SAS, France, (corn cultivars producing the Cry1Ab toxin and PAT enyzme), MIR604 from Syngenta Seeds SAS, France (corn cultivars producing a modified version of the Cry3A toxin, c.f. WO 03/018810), MON 863 from Monsanto Europe S.A., Belgium (corn cultivars producing the Cry3Bb1 toxin), IPC 531 from Monsanto Europe S.A., Belgium (cotton cultivars producing a modified version of the Cry1Ac toxin) and 1507 from Pioneer Overseas Corporation, Belgium (corn cultivars producing the Cry1F toxin and PAT enzyme).

Furthermore, plants are also covered that are by the use of recombinant DNA techniques capable to synthesize one or more proteins to increase the resistance or tolerance of those plants to bacterial, viral or fungal pathogens. Examples of such proteins are the so-called “pathogenesis-related proteins” (PR proteins, see, e.g. EP-A 392 225), plant disease resistance genes (e.g. potato cultivars, which express resistance genes acting against Phytophthora infestans derived from the mexican wild potato Solanum bulbocastanum) or T4-lysozym (e.g. potato cultivars capable of synthesizing these proteins with increased resistance against bacteria such as Erwinia amylvora). The methods for producing such genetically modified plants are generally known to the person skilled in the art and are described, e.g. in the publications mentioned above.

Furthermore, plants are also covered that are by the use of recombinant DNA techniques capable to synthesize one or more proteins to increase the productivity (e.g. bio mass production, grain yield, starch content, oil content or protein content), tolerance to drought, salinity or other growth-limiting environmental factors or tolerance to pests and fungal, bacterial or viral pathogens of those plants.

Furthermore, plants are also covered that contain by the use of recombinant DNA techniques a modified amount of substances of content or new substances of content, specifically to improve human or animal nutrition, e.g. oil crops that produce health-promoting long-chain omega-3 fatty acids or unsaturated omega-9 fatty acids (e.g. Nexera® rape, DOW Agro Sciences, Canada).

Furthermore, plants are also covered that contain by the use of recombinant DNA techniques a modified amount of substances of content or new substances of content, specifically to improve raw material production, e.g. potatoes that produce increased amounts of amylopectin (e.g. Amflora® potato, BASF SE, Germany).

The figures and examples below serve to illustrate the invention and are not to be understood as limiting it.

Analysis:

X-Ray Powder Diffractometry (XRPD):

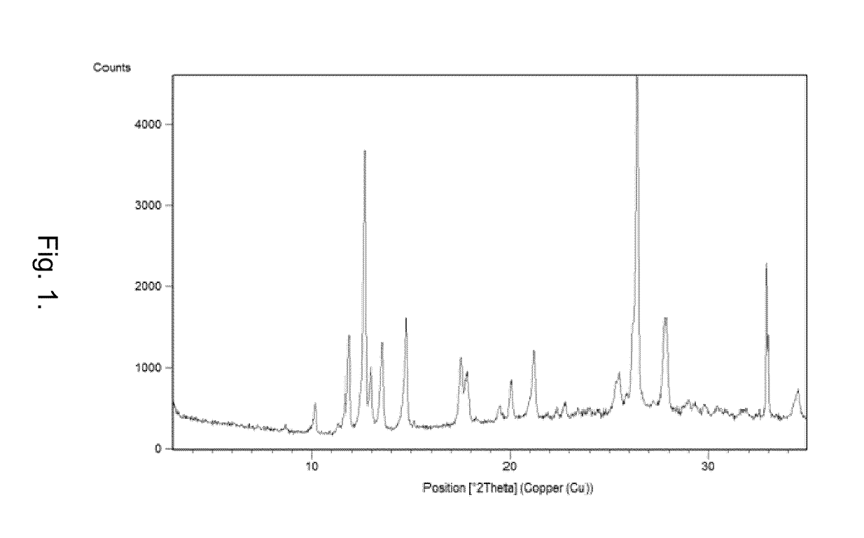

The X-ray powder diffractogram displayed in FIG. 1, was recorded using a Panalytical X'Pert Pro diffractometer (manufacturer: Panalytical) in reflection geometry in the range from 2θ=3°-35° with increments of 0.0167° C. using Cu—Kα radiation (at 25° C.). The recorded 2θ values were used to calculate the stated interplanar spacings d. The intensity of the peaks (y-axis: linear intensity counts) is plotted versus the 2θ angle (x-axis in degrees 2θ).

The single crystal X-ray diffraction data of Form I was collected on a Bruker AXS CCD Detector using graphite Cu—Kα radiation (at −173° C.). The structure was solved using direct methods, refined and expanded by using Fourier techniques with SHELX software package (G. M. Sheldrick, SHELX-97, University of Göttingen, 1997). Absorption correction was performed with SA-DABS software.

Thermal Analysis of the Co-Crystal

DSC was performed on a Mettler Toledo DSC 822e module. The samples were placed in crimped but vented aluminium pans. The samples size in each case was 5 to 10 mg. The thermal behaviour was analized in the range 30-300° C. The heating rate was 5° C./min. The samples were purged with a stream of nitrogen flowing at 150 ml/during the experiment.

Melting points values were confirmed by a Mettler Hot Stage in combination with a light microscope.

The Examples and Figures below serve to illustrate the invention and are not to be understood as limiting it.

FIG. 1: XRPD pattern of the co-crystal comprising comprising pyrimethanil and dithiine tetracarboximide of the formula (I).

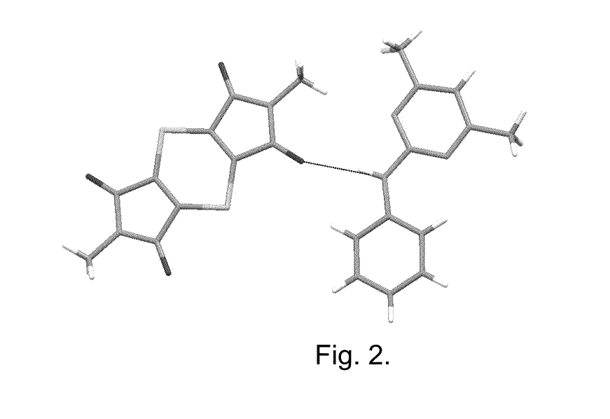

FIG. 2: 1:1 co-crystal comprising 1:1 co-crystal comprising Pyrimethanil and Dithiine. The two molecules interact by an hydrogen bond N—H [symbol] —O.

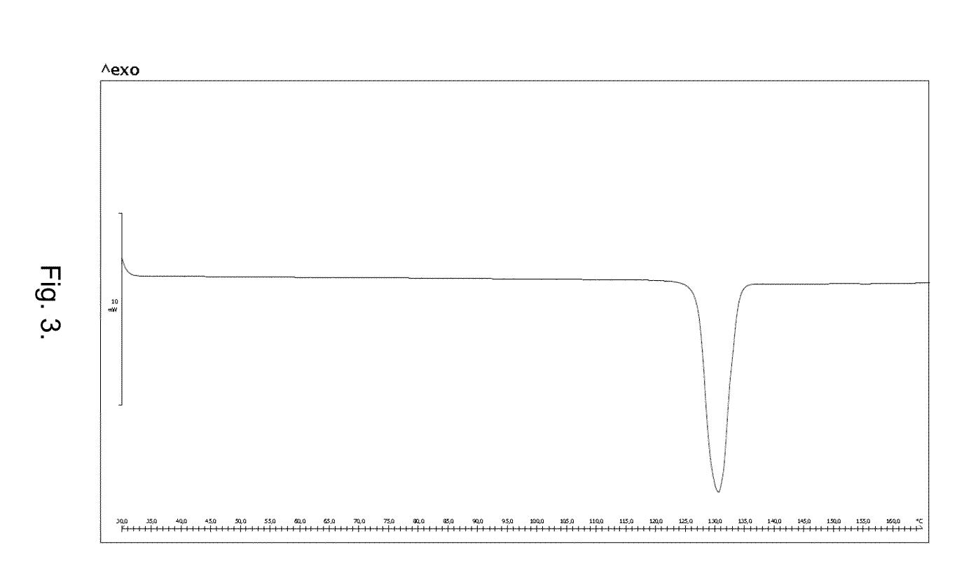

FIG. 3: DSC trace of the co-crystal comprising pyrimethanil and dithiine tetracarboximide of the formula (I).

### EXAMPLES

### Example 1

### Preparation of the Co-Crystal Comprising Pyrimethanil and Dithiine Tetracarboximide of the Formula (I).

Preparation

83 mg of pyrimethanil and 117 mg of dithiine tetracarboximide of the formula (I) are suspended in 2 mL of water or in a mixture of water and polar organic solvent. The suspension solution is stirred until a red powder is obtained (pyrimethanil is a white powder, dithiine tetracarboximide of the formula (I) is a blue powder). The solid material is separated by filtration and dried at 25° C. for 12 hours. The corresponding PXRD pattern and DSC trace are shown in FIG. 1 and in FIG. 3, respectively.

Isothermal Analysis of the Co-Crystals

TG/DTA measurement was carried out on a Seiko TG/DTA 7200 instrument. An open aluminium pan was used and the measurement was carried out under nitrogen flow with a sample weight of 5 to 10 mg. The isothermal TGA for volatility studies were performed at 100 C. and the weight loss was monitored for 12 hours.

Water Solubility of the Co-Crystals

The determination of the amount of the actives in solution was performed on HPLC ACQUITY (Water) system, equipped with PDA_{—}230 nm UV detector and Sample Manager auto-injector.

Waters' Enpower software was used to record the chromatograms and to calculate the chromatographic parameters. Gradient elution (Acetonitrile—0.1% H₃PO₄) was achieved using C18 column, 50×2.1 mm, 1.7 μm BEH. Injection volume was set 1 μL by auto injector. The analysis were performed with rate flux of 0.4 ml/min. UV detection was performed at 245 nm. Peak identities were confirmed by spectrum and retention time comparison. All the analyses were performed at room temperature. All the analyzed solutions were prepared by slurry equilibration experiments. Particularly, water suspensions (KH2PO4/NaOH buffer having pH value of 7) of dithiine, pyrimethanil and the co-crystals were slurried for 1 hour, according with the maximum value of the intrinsic dissolution profile of the pure active. After 60 minutes small samples of about 1.0 ml were recovered with a syringe and filtered through a 0.1 micrometer PVDF Millipore filtration unit. Both solid phase and liquid phase were analyzed by XRPD and HPLC, respectively.

TABLE 11
Physicochemical Properties

| | | | TGA Volatility |
|---|---|---|---|
| | Melting | Solubility | (% weight loss per |
| Compound | Point (° C.) | (mg/L) | minute) |
| pyrimethanil | 96° C. | 58 | 1.20 × 10⁻² |
| dithiine tetracorboxamide | 280° C. | 2 | 5.45 × 10⁻³ |
| of the formula I | | | |
| co-crystal | 131° C. | 26 | 6.94 × 10⁻³ |

Crystal Structure Determination

The single crystal structure of the inventive co-crystal was determined at −173° C. The crystal structure of the inventive crystalline complex has a triclinic crystal system and the space group is P−1. The crystallographical parameters are reported in table 2. The structure analysis reveals that the crystalline complex is a 1:1 mixture of pyrimethanil and dithiine tetracarboximide of the formula (I). The characteristic data of the crystal structure of the complex are shown in table 2:

TABLE 2
Crystallographic data of the co-crystal of pyrimethanil and
dithiine tetracorboxamide of the formula I

| Parameter | |
|---|---|
| Crystal system | Triclinic |
| Space group | P-1 |
| a | 8.2104(3) Å |
| b | 8.9498(3) Å |
| c | 11.5551(4) Å |
| α | 93.435(2)° |
| β | 97.548(2)° |
| γ | 108.317(2)° |
| Volume | 794.446 Å³ |
| Z | 2 |
| R-Factor (%) | 4.21 |

a, b, c = Length of the edges of the unit cell
α, β, γ = Angles of the unit cell
Z = Number of molecules, in the unit cell

Melting Point

The melting points of co-crystales were determined by DSC measurements. The DSC-measurements were performed with a heating rate of 5° C./min, the peak minima are summarized in Table 3 below. The melting point of the inventive co-crystals is significantly higher than the melting point of pyrimethanil.

TABLE 3

| | Melting Point |
|---|---|
| pyrimethanil | 96° C. |
| dithiine tetracorboxamide of the formula I | 280° C. |
| co-crystal | 131° C. |

1-12. (canceled)

13. Co-crystals comprising
(I) pyrimethanil; and
(II) dithiine tetracarboximide of the formula (I)

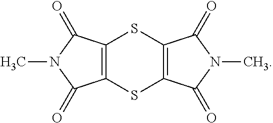 [SMILES: Cn1c(=O)c2sc3c(=O)n(C)c(=O)c3sc2c1=O]

14. The co-crystals of claim 13, wherein the molar ratio of pyrimethanil and dithiine tetracarboximide of the formula (I) is from 2:1 to 1:2.

15. The co-crystals of claim 14, wherein the molar ratio of pyrimethanil and dithiine tetracarboximide of the formula (I) is from 1.5:1 to 1:1.5.

16. The co-crystals of claim 13, having a melting point in the range of 125 to 135°.

17. The co-crystals claim 13, which, in an X-ray powder diffractogram at 25° C. and Cu radiation, shows at least three of the following diffraction lines, given as 2θ values: 10.19±0.2°, 12.66±0.2°, 13.54±0.2°, 14.78±0.2°, 17.50±0.2°, 17.86±0.2°, 26.41±0.2°, 27.83±0.2°.

18. A process for the preparation of the co-crystals of claim 13, comprising the following steps:
i) suspending pyrimethanil and dithiine tetracarboximide of the formula (I) in water,
ii) evaporating the solvent to form the co-crystals.

19. A process for the preparation of the co-crystals of claim 13, comprising the following steps:
i) suspending pyrimethanil and dithiine tetracarboximide of the formula (I) in a mixture of water and a polar organic solvent,
ii) evaporating the solvent to form the co-crystals.

20. An agricultural formulation comprising the co-crystals of claim 13.

21. A method for controlling pests and/or improving the health of plants, wherein the pest, their habitat, breeding grounds, their locus or the plants to be protected against such pest, the soil or plant propagation material are treated with an effective amount of the co-crystals of claim 13.

22. A method for controlling pests and/or improving the health of plants, wherein the pest, their habitat, breeding grounds, their locus or the plants to be protected against such pest, the soil or plant propagation material are treated with an effective amount of the agricultural formulation of claim 20.

23. A method for improving the health of plants, wherein the plant, the locus where the plant is growing or is expected to grow or plant propagation material from which the plant grows is treated with an effective amount of the co-crystals of claim 13.

24. A method for improving the health of plants, wherein the plant, the locus where the plant is growing or is expected to grow or plant propagation material from which the plant grows is treated with an effective amount of the agricultural formulation of claim 20.

25. A method for protection of plant propagation material from pests comprising contacting the plant propagation materials with an effective amount of the co-crystals of claim 13.

26. A method for protection of plant propagation material from pests comprising contacting the plant propagation materials with an effective amount of the agricultural composition of claim 20.

27. A plant propagation material treated with the co-crystals of claim 13 in an amount of from 0.01 g to 10 kg per 100 kg of plant propagation materials.
